(19) United States
(12) Patent Application Publication
(10) Pub. No.: US 2021/0019615 A1
(43) Pub. Date: Jan. 21, 2021

(54) EXTRACTION OF ENTITIES HAVING DEFINED LENGTHS OF TEXT SPANS

(71) Applicant: International Business Machines Corporation, Armonk, NY (US)

(72) Inventors: Tarek Sakakini, Urbana, IL (US); Yu Deng, Yorktown Heights, NY (US); Anup Kalia, Elmsford, NY (US); Ruchi Mahindru, Elmsford, NY (US); Daniela Rosu, Ossining, NY (US); Shu Tao, Irvington, NY (US)

(21) Appl. No.: 16/516,009

(22) Filed: Jul. 18, 2019

(51) Int. Cl. G06N 3/08; G06N 3/04

(52) U.S. Cl. CPC G06N 3/08; G06F 17/278; G06N 3/0454

(57) ABSTRACT

Systems, computer-implemented methods, and computer program products that can facilitate extraction of entities having defined lengths of text spans are provided. According to an embodiment, a system can comprise a memory that stores computer executable components and a processor that executes the computer executable components stored in the memory. The computer executable components can comprise a configuration component that defines different hyperparameters of multiple artificial intelligence models, and determines target hyperparameters of an artificial intelligence model based on performance of the multiple artificial intelligence models. The computer executable components can further comprise an application component that employs the artificial intelligence model to extract one or more entities from a data source based on the target hyperparameters.

### BACKGROUND

The subject disclosure relates to entity extraction, and more specifically, to extraction of entities having defined lengths of text spans.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that can facilitate extraction of entities having defined lengths of text spans are described.

According to an embodiment, a system can comprise a memory that stores computer executable components and a processor that executes the computer executable components stored in the memory. The computer executable components can comprise a configuration component that defines different hyperparameters of multiple artificial intelligence models, and determines target hyperparameters of an artificial intelligence model based on performance of the multiple artificial intelligence models. The computer executable components can further comprise an application component that employs the artificial intelligence model to extract one or more entities from a data source based on the target hyperparameters.

According to another embodiment, a computer-implemented method can comprise defining, by a system operatively coupled to a processor, different hyperparameters of multiple artificial intelligence models. The computer-implemented method can further comprise determining, by the system, target hyperparameters of an artificial intelligence model based on performance of the multiple artificial intelligence models. The computer-implemented method can further comprise employing, by the system, the artificial intelligence model to extract one or more entities from a data source based on the target hyperparameters.

According to another embodiment, a computer program product facilitating extraction of entities having defined lengths of text spans is provided. The computer program product comprising a computer readable storage medium having program instructions embodied therewith, the program instructions executable by a processor to cause the processor to define, by the processor, different hyperparameters of multiple artificial intelligence models. The program instructions are further executable by the processor to cause the processor to determine, by the processor, target hyperparameters of an artificial intelligence model based on performance of the multiple artificial intelligence models. The program instructions are further executable by the processor to cause the processor to employ, by the processor, the artificial intelligence model to extract one or more entities from a data source based on the target hyperparameters.

According to an embodiment, a system can comprise a memory that stores computer executable components and a processor that executes the computer executable components stored in the memory. The computer executable components can comprise a trainer component that trains multiple artificial intelligence models to learn entities having different lengths of text spans based on different defined hyperparameters of the multiple artificial intelligence models. The computer executable components can further comprise a configuration component that determines target hyperparameters of an artificial intelligence model based on performance of the multiple artificial intelligence models.

According to another embodiment, a computer-implemented method can comprise training, by a system operatively coupled to a processor, multiple artificial intelligence models to learn entities having different lengths of text spans based on different defined hyperparameters of the multiple artificial intelligence models. The computer-implemented method can further comprise determining, by the system, target hyperparameters of an artificial intelligence model based on performance of the multiple artificial intelligence models.

### DESCRIPTION OF THE DRAWINGS

FIG. 1 illustrates a block diagram of an example, non-limiting system that can facilitate extraction of entities having defined lengths of text spans in accordance with one or more embodiments described herein.

FIG. 2 illustrates an example, non-limiting model that can facilitate extraction of entities having defined lengths of text spans in accordance with one or more embodiments described herein.

FIG. 3 illustrates an example, non-limiting model that can facilitate extraction of entities having defined lengths of text spans in accordance with one or more embodiments described herein.

FIG. 3A illustrates an example, non-limiting model that can facilitate extraction of entities having defined lengths of text spans in accordance with one or more embodiments described herein.

FIG. 3B illustrates an example, non-limiting model that can facilitate extraction of entities having defined lengths of text spans in accordance with one or more embodiments described herein.

FIG. 4 illustrates example, non-limiting information that can facilitate extraction of entities having defined lengths of text spans in accordance with one or more embodiments described herein.

FIG. 5 illustrates a block diagram of an example, non-limiting system that can facilitate extraction of entities having defined lengths of text spans in accordance with one or more embodiments described herein.

FIG. 6 illustrates a block diagram of an example, non-limiting system that can facilitate extraction of entities having defined lengths of text spans in accordance with one or more embodiments described herein.

FIG. 7 illustrates a flow diagram of an example, non-limiting computer-implemented method that can facilitate extraction of entities having defined lengths of text spans in accordance with one or more embodiments described herein.

FIG. 8 illustrates a flow diagram of an example, non-limiting computer-implemented method that can facilitate extraction of entities having defined lengths of text spans in accordance with one or more embodiments described herein.

FIG. 9 illustrates a flow diagram of an example, non-limiting computer-implemented method that can facilitate extraction of entities having defined lengths of text spans in accordance with one or more embodiments described herein.

FIG. 10 illustrates a block diagram of an example, non-limiting operating environment in which one or more embodiments described herein can be facilitated.

FIG. 11 illustrates a block diagram of an example, non-limiting cloud computing environment in accordance with one or more embodiments of the subject disclosure.

FIG. 12 illustrates a block diagram of example, non-limiting abstraction model layers in accordance with one or more embodiments of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

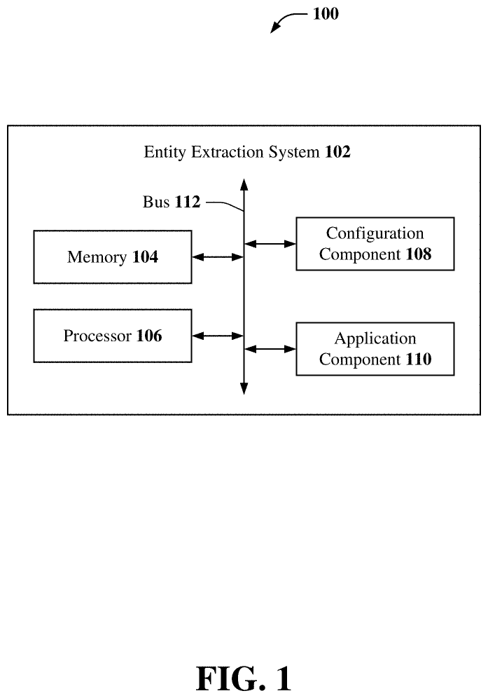

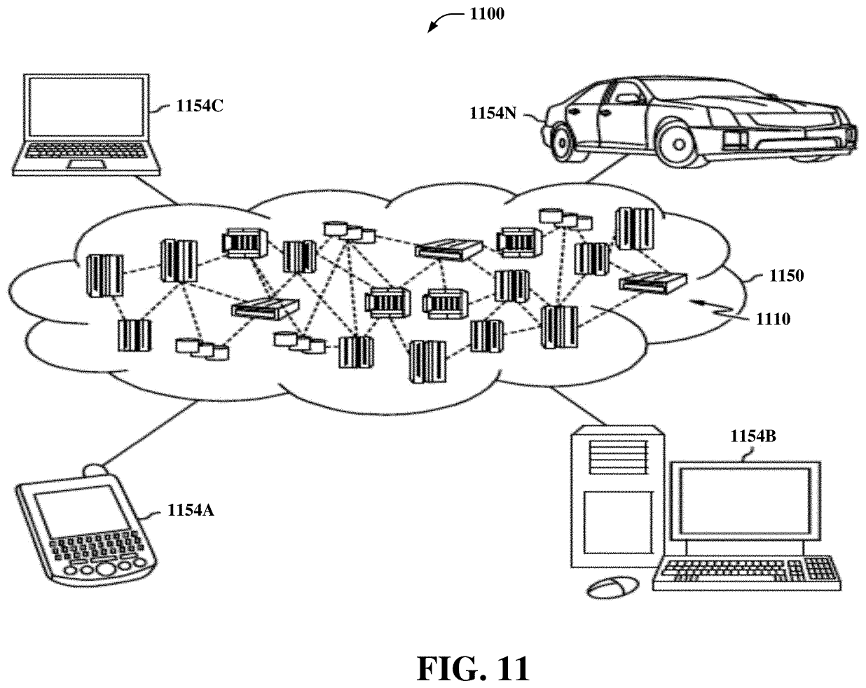

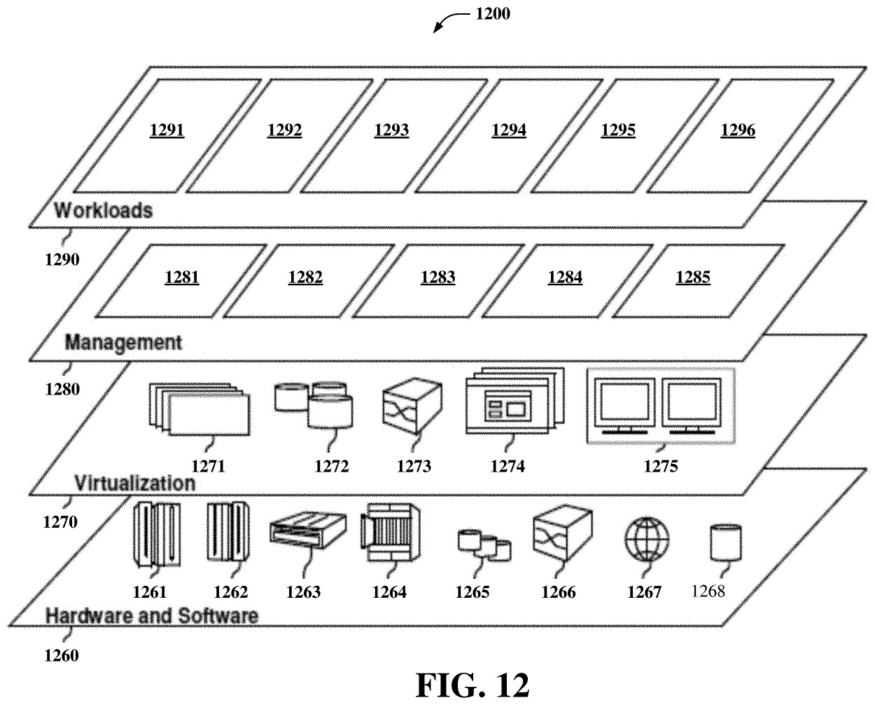

FIG. 1 illustrates a block diagram of an example, non-limiting system 100 that can facilitate extraction of entities having defined lengths of text spans in accordance with one or more embodiments described herein. For example, system 100 can facilitate extraction of one or more entities that require different lengths of context span to be classified correctly, for instance, by a model (e.g., an artificial intelligence (AI) model, a machine learning (ML) model, etc.). In some embodiments, system 100 can comprise an entity extraction system 102. In some embodiments, entity extraction system 102 can be associated with a cloud computing environment. For example, entity extraction system 102 can be associated with cloud computing environment 1150 described below with reference to FIG. 11 and/or one or more functional abstraction layers described below with reference to FIG. 12 (e.g., hardware and software layer 1260, virtualization layer 1270, management layer 1280, and/or workloads layer 1290). In some embodiments, entity extraction system 102 can comprise a memory 104, a processor 106, a configuration component 108, an application component 110, and/or a bus 112.

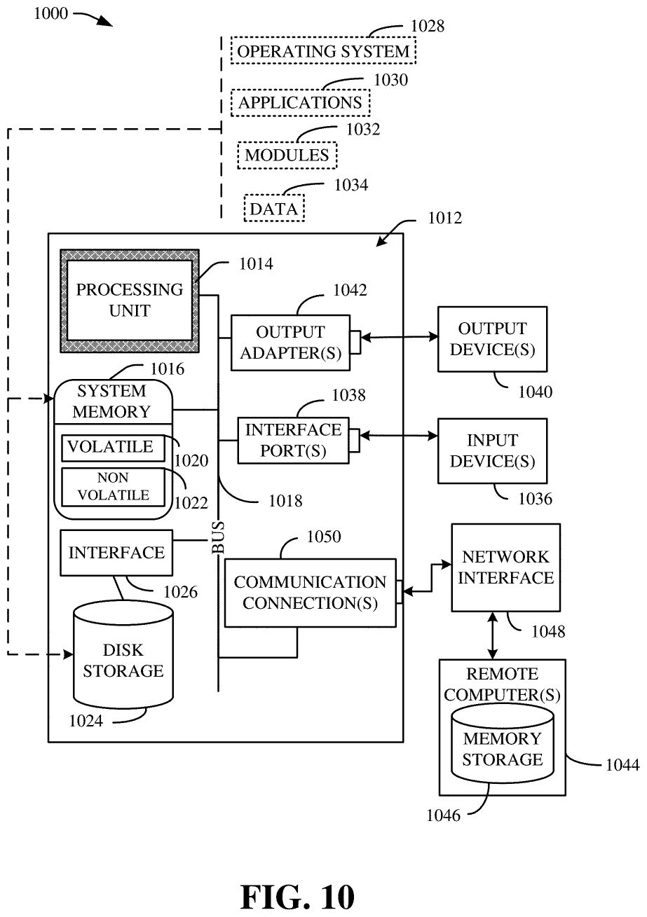

It should be appreciated that the embodiments of the subject disclosure depicted in various figures disclosed herein are for illustration only, and as such, the architecture of such embodiments are not limited to the systems, devices, or components depicted therein. For example, in some embodiments, system 100 and/or entity extraction system 102 can further comprise various computer or computing-based elements described herein with reference to operating environment 1000 and FIG. 10. In several embodiments, such computer or computing-based elements can be used in connection with implementing one or more of the systems, devices, components, or computer-implemented operations shown and described in connection with FIG. 1 or other figures disclosed herein.

According to multiple embodiments, memory 104 can store one or more computer or machine readable, writable, or executable components or instructions that, when executed by processor 106, can facilitate execution of operations defined by the executable component(s) or instruction(s). For example, memory 104 can store computer or machine readable, writable, or executable components or instructions that, when executed by processor 106, can facilitate execution of the various functions described herein relating to entity extraction system 102, configuration component 108, application component 110, and/or another component associated with entity extraction system 102, as described herein with or without reference to the various figures of the subject disclosure.

In some embodiments, memory 104 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to system memory 1016 and FIG. 10. Such examples of memory 104 can be employed to implement any embodiments of the subject disclosure.

According to multiple embodiments, processor 106 can comprise one or more types of processors or electronic circuitry that can implement one or more computer and/or machine readable, writable, and/or executable components and/or instructions that can be stored on memory 104. For example, processor 106 can perform various operations that can be specified by such computer and/or machine readable, writable, and/or executable components and/or instructions including, but not limited to, logic, control, input/output (I/O), arithmetic, and/or the like. In some embodiments, processor 106 can comprise one or more central processing unit, multi-core processor, microprocessor, dual microprocessors, microcontroller, System on a Chip (SOC), array processor, vector processor, and/or another type of processor. Further examples of processor 106 are described below with reference to processing unit 1014 and FIG. 10. Such examples of processor 106 can be employed to implement any embodiments of the subject disclosure.

In some embodiments, entity extraction system 102, memory 104, processor 106, configuration component 108, application component 110, and/or another component of entity extraction system 102 as described herein can be communicatively, electrically, and/or operatively coupled to one another via a bus 112 to perform functions of system 100, entity extraction system 102, and/or any components coupled therewith. In several embodiments, bus 112 can comprise one or more memory bus, memory controller, peripheral bus, external bus, local bus, and/or another type of bus that can employ various bus architectures. Further examples of bus 112 are described below with reference to system bus 1018 and FIG. 10. Such examples of bus 112 can be employed to implement any embodiments of the subject disclosure.

According to multiple embodiments, entity extraction system 102 can comprise any type of component, machine, device, facility, apparatus, and/or instrument that comprises a processor and/or can be capable of effective and/or operative communication with a wired and/or wireless network. All such embodiments are envisioned. For example, entity extraction system 102 can comprise a server device, a computing device, a general-purpose computer, a special-purpose computer, a quantum computing device (e.g., a quantum computer, a quantum processor, etc.), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

In some embodiments, entity extraction system 102 can be coupled (e.g., communicatively, electrically, operatively, etc.) to one or more external systems, sources, and/or devices (e.g., computing devices, communication devices, etc.) via a data cable (e.g., High-Definition Multimedia Interface (HDMI), recommended standard (RS) 232, Ethernet cable, etc.). In some embodiments, entity extraction system 102 can be coupled (e.g., communicatively, electrically, operatively, etc.) to one or more external systems, sources, and/or devices (e.g., computing devices, communication devices, etc.) via a network.

According to multiple embodiments, such a network can comprise wired and/or wireless networks, including, but not limited to, a cellular network, a wide area network (WAN) (e.g., the Internet), and/or a local area network (LAN). For example, entity extraction system 102 can communicate with one or more external systems, sources, and/or devices, for instance, computing devices (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In such an example, entity extraction system 102 can thus include hardware (e.g., a central processing unit (CPU), a transceiver, a decoder), software (e.g., a set of threads, a set of processes, software in execution) and/or a combination of hardware and software that facilitates communicating information between entity extraction system 102 and external systems, sources, and/or devices (e.g., computing devices, communication devices, etc.).

In some embodiments, entity extraction system 102 can comprise one or more computer and/or machine readable, writable, and/or executable components and/or instructions that, when executed by processor 106, can facilitate performance of operations defined by such component(s) and/or instruction(s). Further, in some embodiments, any component associated with entity extraction system 102, as described herein with or without reference to the various figures of the subject disclosure, can comprise one or more computer and/or machine readable, writable, and/or executable components and/or instructions that, when executed by processor 106, can facilitate performance of operations defined by such component(s) and/or instruction(s). For example, configuration component 108, application component 110, and/or any other components associated with entity extraction system 102 as disclosed herein (e.g., communicatively, electronically, and/or operatively coupled with or employed by entity extraction system 102), can comprise such computer and/or machine readable, writable, and/or executable component(s) and/or instruction(s). Consequently, in some embodiments, entity extraction system 102 and/or any components associated therewith as disclosed herein, can employ processor 106 to execute such computer and/or machine readable, writable, and/or executable component(s) and/or instruction(s) to facilitate performance of one or more operations described herein with reference to entity extraction system 102 and/or any such components associated therewith.

In some embodiments, entity extraction system 102 can facilitate performance of operations executed by and/or associated with configuration component 108, application component 110, and/or another component associated with entity extraction system 102 as disclosed herein. For example, as described in detail below, entity extraction system 102 can facilitate (e.g., via processor 106): defining different hyperparameters of multiple artificial intelligence models; determining target hyperparameters of an artificial intelligence model based on performance of the multiple artificial intelligence models; and/or employing the artificial intelligence model to extract one or more entities from a data source based on the target hyperparameters. In some embodiments, at least one of the artificial intelligence model or the multiple artificial intelligence models comprise at least one of a deep neural network model, a recurring neural network model, a long short term memory model, an elastic long short term memory model, or a decoupled elastic long short term memory model. In some embodiments, the target hyperparameters comprise a target forget gate bias and a target input gate bias of the artificial intelligence model, and where the different hyperparameters comprise different defined forget gate biases and different defined input gate biases of the multiple artificial intelligence models. In some embodiments, entity extraction system 102 can further facilitate (e.g., via processor 106): defining the different hyperparameters based on at least one of different content domains, different knowledge sources, different data types, or different applications; and/or tuning one or more hyperparameters of the multiple artificial intelligence models to define the different hyperparameters of the multiple artificial intelligence models.

In some embodiments, entity extraction system 102 can further facilitate (e.g., via processor 106): training multiple artificial intelligence models to learn entities having different lengths of text spans based on different defined hyperparameters of the multiple artificial intelligence models; and/or determining target hyperparameters of an artificial intelligence model based on performance of the multiple artificial intelligence models. In some embodiments, at least one of the artificial intelligence model or the multiple artificial intelligence models comprise at least one of a deep neural network model, a recurring neural network model, a long short term memory model, an elastic long short term memory model, or a decoupled elastic long short term memory model. In some embodiments, the target hyperparameters comprise a target forget gate bias and a target input gate bias of the artificial intelligence model, and where the different defined hyperparameters comprise different defined forget gate biases and different defined input gate biases of the multiple artificial intelligence models. In some embodiments, entity extraction system 102 can further facilitate (e.g., via processor 106): tuning one or more hyperparameters of the multiple artificial intelligence models to define the different defined hyperparameters of the multiple artificial intelligence models, and wherein the different defined hyperparameters are defined based on at least one of different content domains, different knowledge sources, different data types, or different applications.

According to multiple embodiments, configuration component 108 can define different hyperparameters of multiple artificial intelligence (AI) models, and determine target hyperparameters of an AI model based on performance of the multiple AI models. For example, configuration component 108 can define different hyperparameters of multiple AI models, and determine target hyperparameters of an AI model based on performance of the multiple AI models, where such target hyperparameters of the AI model can include, but are not limited to, a target forget gate bias, a target input gate bias, a target forget gate activation vector, a target input gate activation vector, and/or another target hyperparameter. In another example, configuration component 108 can define different hyperparameters of multiple AI models, and determine target hyperparameters of an AI model based on performance of the multiple AI models, where such different hyperparameters of the multiple AI models can include, but are not limited to, different defined forget gate biases, different defined input gate biases, different defined forget gate activation vectors, different defined input gate activation vectors, and/or another different hyperparameter. In this example, such different hyperparameters can be defined by configuration component 108 based on, for instance, at least one of different content domains, different knowledge sources, different data types, or different applications.

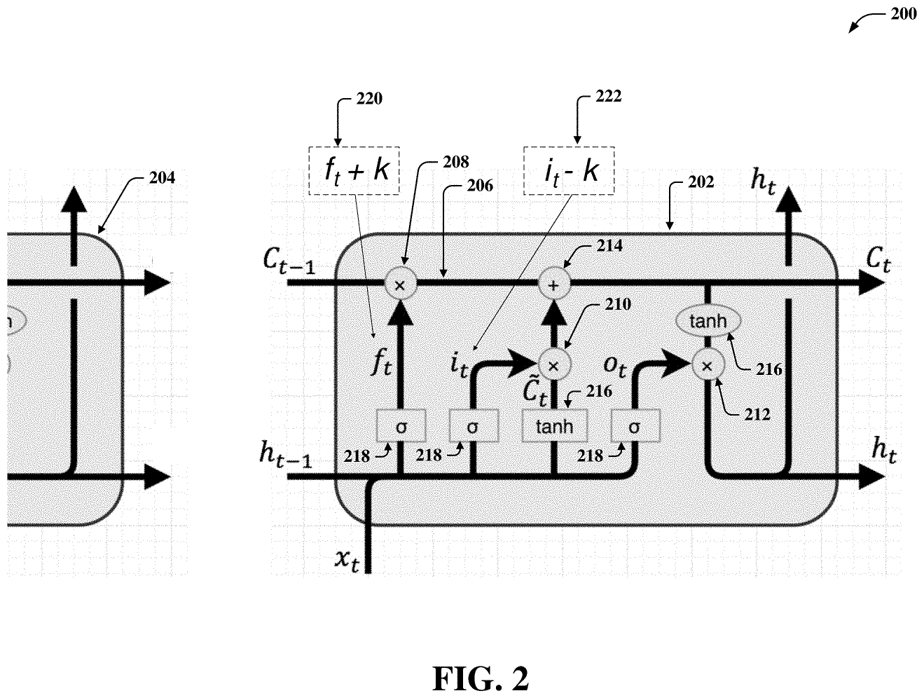

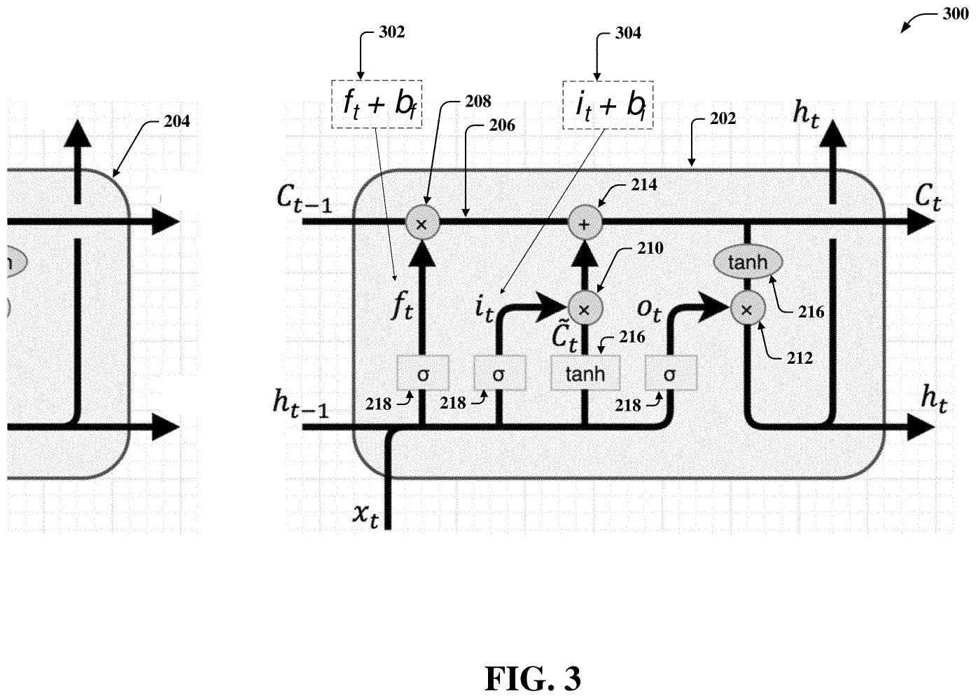

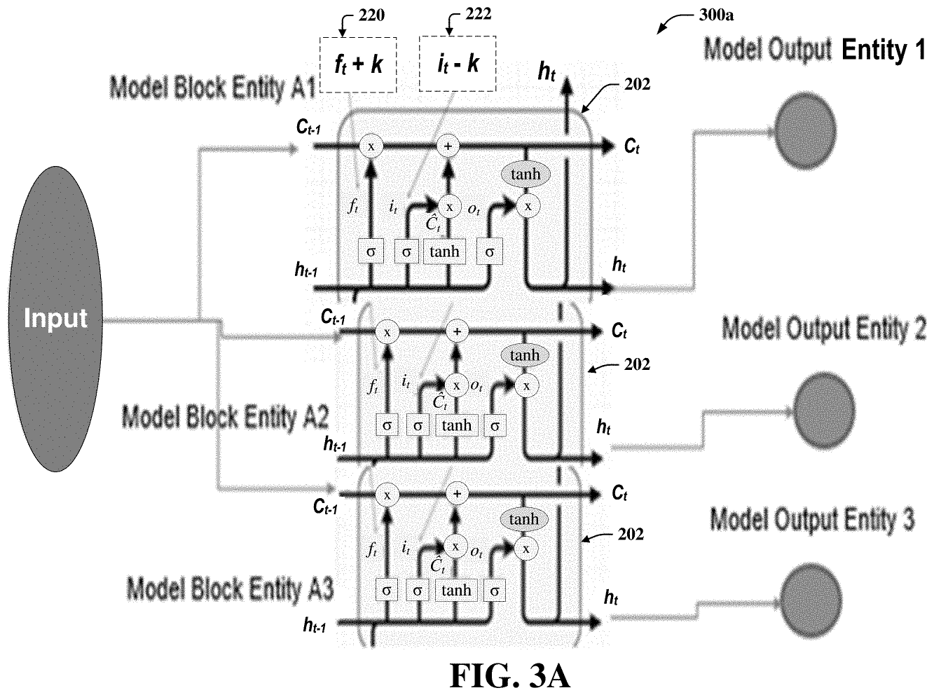

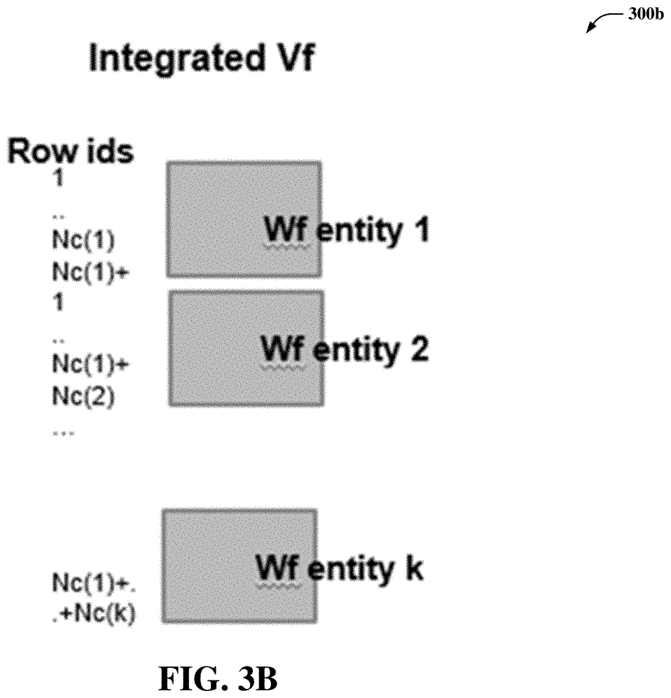

In some embodiments, configuration component 108 can define different hyperparameters of multiple AI models, and determine target hyperparameters of an AI model based on performance of the multiple AI models, where such an AI model and/or multiple AI models can include, but are not limited to, a deep neural network model, a recurring neural network model, a long short term memory model, an elastic long short term memory model, a decoupled elastic long short term memory model, and/or another AI model. In some embodiments, configuration component 108 can define different hyperparameters of multiple AI models, and determine target hyperparameters of an AI model based on performance of the multiple AI models, where such an AI model can comprise, for example, a collection of a plurality of AI models trained with different hyperparameters. In some embodiments, configuration component 108 can define different hyperparameters of multiple AI models, and determine target hyperparameters of an AI model based on performance of the multiple AI models, where such an AI model and/or multiple AI models can include, but is not limited to, model 200 and/or model 300 described below with reference to FIGS. 2 and 3.

FIG. 2 illustrates an example, non-limiting model 200 that can facilitate extraction of entities having defined lengths of text spans in accordance with one or more embodiments described herein. For example, model 200 can facilitate extraction of one or more entities that require different lengths of context span to be classified correctly, for instance, by a model (e.g., model 200, an AI model, a ML model, etc.). Repetitive description of like elements and/or processes employed in respective embodiments is omitted for sake of brevity.

According to multiple embodiments, model 200 can comprise an alternative version (e.g., modified version) of a long short term memory (LSTM) model. For example, in some embodiments, model 200 can comprise an elastic long short term memory model (elastic LSTM).

In some embodiments, model 200 can comprise a hidden layer 202 that can receive data input xₜ at a time point t from an input layer and data input hₜ₋₁ from itself (e.g., from hidden layer 204 depicted in FIG. 2), where data input hₜ₋₁ can comprise data input from a time point t−1. In some embodiments, hidden layer 202 can generate a data output hₜ at time point t, which can be used as data input by an output layer (not illustrated in FIG. 2) and by itself at a time point t+1 (e.g., can be used as data input to hidden layer 202 at a time point t+1, not illustrated in FIG. 2).

In some embodiments, hidden layer 202 can comprise a memory cell 206 that can receive memory cell data input Cₜ₋₁ at time point t from itself, where memory cell data input Cₜ₋₁ can comprise memory cell data input from a time point t−1. In some embodiments, memory cell 206 can generate a memory cell data output Cₜ at time point t, where such memory cell data output Cₜ can be used as memory cell data input by itself at a time point t+1 (e.g., can be used as memory cell data input to memory cell 206 at a time point t+1, not illustrated in FIG. 2).

In some embodiments, hidden layer 202 can comprise valves 208, 210, 212 (e.g., denoted as an x in FIG. 2) that can include, but are not limited to, input valves, forget valves, memory valve, and/or output valves. In some embodiments, valves 208, 210, 212 can be set to an open position, closed position, or opened to a certain extent. In some embodiments, valves 208, 210, 212 can function to restrict and/or allow data (e.g., vectors, vector values, memory cell data, etc.) to flow into and/or out of one or more components of hidden layer 202 (e.g., through memory cell 206, etc.) and/or hidden layer 202 itself.

In some embodiments, hidden layer 202 can comprise a joint 214 (e.g., denoted as +in FIG. 2) that can be indicative of an intersection and/or a junction that can facilitate data flowing through a component of hidden layer 202 and/or the addition of new (e.g., additional) data that can flow into and/or out of such a component. In some embodiments, hidden layer 202 can comprise a transformation function 216 (e.g., denoted as tanh in FIG. 2) that can transform a value (e.g., a value of a vector, a value of an element of a vector, etc.) to be within a range between −1 to 1, which can be necessary from a mathematical perspective to facilitate operation of model 200. In some embodiments, hidden layer 202 can comprise one or more sigmoid activation functions 218 (e.g., denoted as 6 in FIG. 2) that can determine whether a certain valve 208, 210, 212 should be open, open to some extent, or closed.

In some embodiments, valve 208 can comprise a forget valve (also referred to as a forget gate) that can prevent, limit, and/or fully allow memory cell data input Cₜ₋₁ into memory cell 206. In some embodiments, valve 210 can comprise a memory valve (e.g., also referred to as an input gate) that can prevent, limit, and/or fully allow data input xₜ and/or data input hₜ₋₁ into memory cell 206. In some embodiments, each of the inputs and/or outputs of model 200 and/or hidden layer 202 described above can comprise vectors. In some embodiments, hidden layer 202 can comprise a forget gate that can be represented by a forget gate activation vector denoted as fₜ in FIG. 2, where t denotes a time point (e.g., a time instance). In some embodiments, hidden layer 202 can comprise an input gate that can be represented by an input gate activation vector denoted as iₜ in FIG. 2, where t denotes a time point (e.g., a time instance).

In some embodiments, forget gate activation vector fₜ can comprise a tunable forget gate activation vector 220 denoted as fₜ+k in FIG. 2, where k can comprise a tunable hyperparameter (e.g., where such a hyperparameter can comprise a scalar value) that can be adjusted to facilitate controlling the data (e.g., vectors, vector values, memory cell data, etc.) that can flow into and/or out of memory cell 206. Additionally, or alternatively, in some embodiments, input gate activation vector iₜ can comprise a tunable input gate activation vector 222 denoted as iₜ−k in FIG. 2, where k can comprise a tunable hyperparameter (e.g., where such a hyperparameter can comprise a scalar value) that can be adjusted to facilitate controlling the data (e.g., vectors, vector values, memory cell data, etc.) that can flow into and/or out of memory cell 206.

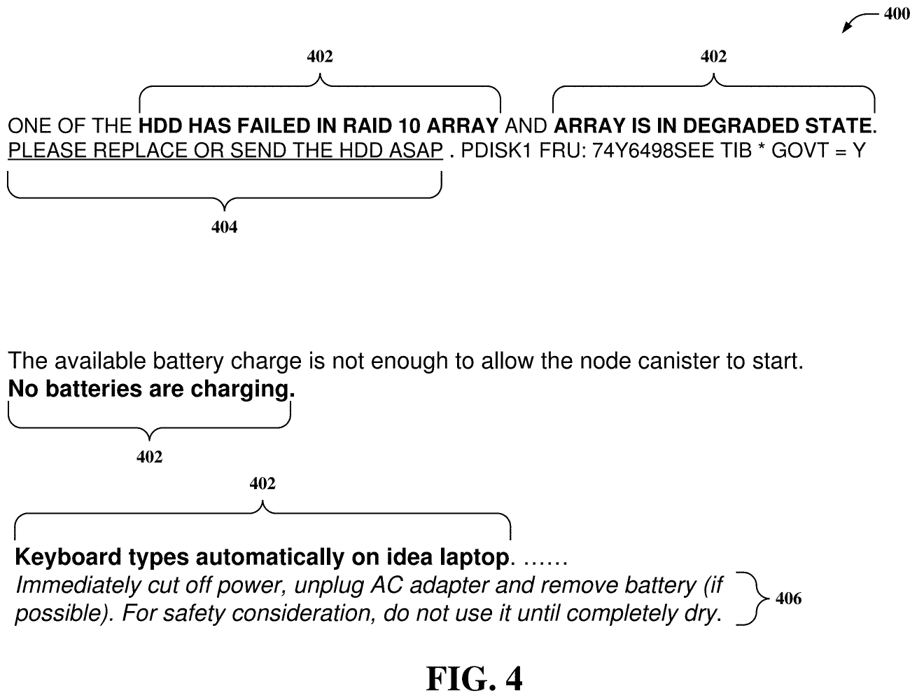

In some embodiments, tunable hyperparameter k of tunable forget gate activation vector 220 and/or tunable input gate activation vector 222 can be adjusted (e.g., via configuration component 108 and/or tuner component 502 as described below) to facilitate controlling the data that can flow into and/or out of memory cell 206 based on one or more attributes of an entity (e.g., a text entity such as, for instance, one or more words) that can be extracted (e.g., via application component 110 as described below) from a data source using model 200. For example, tunable hyperparameter k of tunable forget gate activation vector 220 and/or tunable input gate activation vector 222 can be adjusted to facilitate controlling the data that can flow into and/or out of memory cell 206 based on one or more attributes of such an entity including, but not limited to: the length of the entity and/or the length of a sequence of entities (e.g., the quantity of text characters and/or words in a single entity and/or in a sequence of entities); the type of entity (e.g., an entity defined as a symptom, a resolution, an action request, etc.); a content domain corresponding to an entity (e.g., information technology (IT), finance, health care, etc.); a knowledge source corresponding to an entity (e.g., a database, a network, a textual document, a conversation log of a cognitive conversation agent, a data graph, a semantic engine, inference engine, etc.); an application corresponding to an entity (e.g., a search engine, a cognitive conversation agent, a cognitive expert agent, etc.); and/or another attribute of such an entity. For instance, tunable hyperparameter k of tunable forget gate activation vector 220 and/or tunable input gate activation vector 222 can be adjusted to facilitate allowing one or more entities having a defined length (e.g., a defined quantity of text characters and/or words in a single entity and/or in a sequence of entities) to flow into and/or out of memory cell 206, where such one or more entities can be of a certain type and/or correspond to a certain content domain, a certain knowledge source, and/or a certain application as described above. In some embodiments, tunable hyperparameter k of tunable forget gate activation vector 220 and/or tunable input gate activation vector 222 can be adjusted to facilitate controlling the data that can flow into and/or out of memory cell 206 based on one or more attributes of, for example, entities 402, 404, 406 described below with reference to FIG. 4, where model 200 can be employed (e.g., via application component 110) to extract entities 402, 404, 406 from a data source.

FIG. 3 illustrates an example, non-limiting model 300 that can facilitate extraction of entities having defined lengths of text spans in accordance with one or more embodiments described herein. For example, model 300 can facilitate extraction of one or more entities that require different lengths of context span to be classified correctly, for instance, by a model (e.g., model 200, model 300, an AI model, a ML model, etc.). Repetitive description of like elements and/or processes employed in respective embodiments is omitted for sake of brevity.

According to multiple embodiments, model 300 can comprise an alternative version (e.g., modified version) of a long short term memory (LSTM) model. For example, in some embodiments, model 300 can comprise a decoupled elastic long short term memory model (elastic LSTM).

In some embodiments, model 300 can comprise an example, non-limiting alternative embodiment of model 200 described above with reference to FIG. 2, where hidden layer 202 of model 300 can comprise a tunable forget gate activation vector 302 denoted as fₜ+b_{f} in FIG. 3 and/or a tunable input gate activation vector 304 denoted as iₜ+bᵢ in FIG. 3. In some embodiments, b_{f} and/or bᵢ of tunable forget gate activation vector 302 and tunable input gate activation vector 304, respectively, can comprise tunable hyperparameters that can be adjusted to facilitate controlling the data that can flow into and/or out of memory cell 206. For example, b_{f} and/or bᵢ of tunable forget gate activation vector 302 and tunable input gate activation vector 304, respectively, can comprise hyperparameters comprising scalar values that can be used to transform (e.g., adjust) tunable forget gate activation vector 302 and/or tunable input gate activation vector 304. For instance, b_{f} of tunable forget gate activation vector 302 can comprise a forget gate bias comprising a scalar value that can be added to each element of forget gate activation vector fₜ. In another example, bᵢ of tunable input gate activation vector 304 can comprise an input gate bias comprising a scalar value that can be added to each element of input gate activation vector iₜ.

In some embodiments, b_{f} of tunable forget gate activation vector 302 and/or bᵢ of tunable input gate activation vector 304 can be tuned in a manner similar to that of other hyperparameters of an artificial intelligence (AI) model and/or a machine learning (ML) model. For example, an entity (e.g., a programmer, a device, a computer, a robot, a machine, an artificial intelligence driven module, a human, etc.) can assign different values to b_{f} and/or bᵢ at training time, and check which value does the best on a held-out validation dataset. For instance, such an entity can assign different values to b_{f} and/or bᵢ including, but not limited to: 0.1, 1.0, 10.0, 100.0, and/or another value. In some embodiments, b_{f} and bᵢ can enable an entity (e.g., a device, a computer, a robot, a machine, an artificial intelligence driven module, a human, etc.) to control the information flow in a recurrent LSTM setting. Accordingly, in some embodiments, if such an entity has information about a task, such as artifacts being lengthy as in information technology (IT) support, the entity can expand and spread out the context vision of the LSTM back into memory further. Thus, in some embodiments, enhancing performance on a task with lengthy artifacts.

In some embodiments, tunable hyperparameter fₜ and/or iₜ of tunable forget gate activation vector 302 and tunable input gate activation vector 304, respectively, can be adjusted (e.g., via configuration component 108 and/or tuner component 502 as described below) to facilitate controlling the data that can flow into and/or out of memory cell 206 based on one or more attributes of an entity (e.g., a text entity such as, for instance, one or more words) that can be extracted from a data source using model 300. For example, tunable hyperparameter fₜ and/or iₜ of tunable forget gate activation vector 302 and tunable input gate activation vector 304, respectively, can be adjusted to facilitate controlling the data that can flow into and/or out of memory cell 206 based on one or more attributes of such an entity including, but not limited to: the length of the entity and/or the length of a sequence of entities (e.g., the quantity of text characters and/or words in a single entity and/or in a sequence of entities); the type of entity (e.g., an entity defined as a symptom, a resolution, an action request, etc.); and/or another attribute of such an entity. For instance, tunable hyperparameter fₜ and/or iₜ of tunable forget gate activation vector 302 and tunable input gate activation vector 304, respectively, can be adjusted to facilitate allowing one or more entities having a defined length (e.g., a defined quantity of text characters and/or words in a single entity and/or in a sequence of entities) to flow into and/or out of memory cell 206. In some embodiments, tunable hyperparameter fₜ and/or iₜ of tunable forget gate activation vector 302 and tunable input gate activation vector 304, respectively, can be adjusted to facilitate controlling the data that can flow into and/or out of memory cell 206 based on one or more attributes of, for example, entities 402, 404, 406 described below with reference to FIG. 4, where model 300 can be employed (e.g., via application component 110) to extract entities 402, 404, 406 from a data source.

FIG. 3A illustrates an example, non-limiting model 300a that can facilitate extraction of entities having defined lengths of text spans in accordance with one or more embodiments described herein. For example, model 300a can facilitate extraction of one or more entities that require different lengths of context span to be classified correctly, for instance, by a model (e.g., model 200, model 300, model 300a, an AI model, a ML model, etc.). Repetitive description of like elements and/or processes employed in respective embodiments is omitted for sake of brevity.

In some embodiments, model 300a can comprise an example, non-limiting alternative embodiment of model 200 and/or model 300 described above with reference to FIGS. 2 and 3, respectively, where model 300a can comprise multiple model block entities (denoted Model Block Entity A1, A2, A3 in FIG. 3A) input to multiple hidden layers 202 and/or multiple model output entities (denoted Model Output Entity 1, 2, 3 in FIG. 3A) output from such hidden layers 202 (e.g., as illustrated in FIG. 3A). In some embodiments, model 300a can be defined by the following equations, where several per-artifact tuned models can be used to define one integrated-artifact model that can use the tuned values described above (e.g., b_{f} and/or bᵢ) and/or ideally would want to represent that C and H are the same and the nodes in between are structured in blocks for each entity:

fₜ=σ(W_{f}·[hₜ₋₁, xₜ]+b_{f})

iₜ=σ(Wᵢ·[hₜ₋₁, xₜ]+bᵢ)

\tilde{C}ₜ=tanh(W_{C}·[hₜ₋₁, xₜ]+b_{C})

oₜ=σ(Wₒ[hₜ₋₁, xₜ]+bₒ)

hₜ=oₜ*tanh(Cₜ)

Cₜ=fₜ*Cₜ₋₁+iₜ*\tilde{C}ₜ

Forget gate at step t:ft=\sigma(bf,Wf[ht−1,Xt]+mf) where Xt is input in step t, h[t−1] is output in step (t−1), Wf is a matrix of size Nc×(size of h+size of Xt), mf is an array of size Nc, the size of the cell memory. In some embodiments, the expression of sigmoid function \sigma can depend on hyperparameter b_{f}. In some embodiments, the value of Nc might depend on hyperparameter b_{f} and bᵢ.

Input gate at step t: it=\sigma(bi,Wi[ht−1,Xt]+mi) where Xt is input in step t, h[t−1] is output in step (t−1), Wi is a matrix of size Nc×(number of lines in h+number of lines in Xt), mi is an array of size Nc. The expression of sigmoid function \sigma might depend on hyperparameter bᵢ.

The cell state at step t: Ct=ft*Ct−1+it*tanh(WC[ht−1,Xt]+mc).

The output gate at step t′ht=\sigma(Wo[ht−1,Xt]+mo)*tanh(Ct).

In some embodiments, model 300a can be trained to take a stream of input and produce a specific output. In an embodiment, the input is text from technical domain documents (e g , manuals), and the output is a marker that identifies of a domain specific entity, such as product, product model, product parts, etc. In an embodiment, for technical support domain, such entities might also include a product configuration or state attributes, defect symptom, status check validation, etc. In some embodiments, an AI application might have to identify two or more of such entities in order to produce the right responses. In one embodiment, model 300a can be trained and tuned for each of these entities. In some embodiments, a set of hyperparameters (e.g., b_{f}, bi, etc.) can be determined for each of these models. In some embodiments, for efficiency of AI application, a new integrated model (e.g., model 300b as described below and illustrated in FIG. 3B) can be trained to receive the same input and produce multiple outputs, one output for each of the entities of interest.

FIG. 3B illustrates an example, non-limiting model 300b that can facilitate extraction of entities having defined lengths of text spans in accordance with one or more embodiments described herein. For example, model 300b can facilitate extraction of one or more entities that require different lengths of context span to be classified correctly, for instance, by a model (e.g., model 200, model 300, model 300a, model 300b, an AI model, a ML model, etc.). Repetitive description of like elements and/or processes employed in respective embodiments is omitted for sake of brevity.

In some embodiments, model 300b can comprise an example, non-limiting alternative embodiment of model 200, model 300, and/or model 300a described above with reference to FIGS. 2, 3, and 3A, respectively. In one embodiment, model 300b can comprise an integrated model comprising block composition of individual models. In some embodiments, Vf, Vi, Vc, Vo and/or pf, pi, pc, po can correspond to parameters Wf, Wi, Wc, Wo and/or mf, mi, mc, mo above, respectively. In some embodiments, Vf is composed by taking the lines of the Wf for each of the target entities. In some embodiments, similar for the other matrix and arrays. In some embodiments, the output of the new model (e.g., model 300b) is composed by staking vertically the output ht for each of the per entity models.

In some embodiments, the hyper parameters of per-entity models (e.g., model 200, model 300, model 300a, etc.) are used for the corresponding model blocks of the integrated model (e.g., model 300b). In some embodiments, thus, the sigmoid and tanh functions might have different expressions for the different blocks that correspond to the different entities.

Returning to FIG. 1, as described above, configuration component 108 can define different hyperparameters of multiple AI models, and determine target hyperparameters of an AI model based on performance of the multiple AI models. For example, configuration component 108 can define different hyperparameters of multiple versions of model 200 and/or model 300, and determine target hyperparameters of an AI model based on performance of such multiple versions of model 200 and/or model 300.

In some embodiments, configuration component 108 can define different hyperparameters of multiple versions of model 200 and/or model 300, where such different hyperparameters can include, but are not limited to: different defined forget gate biases of tunable forget gate activation vector 220; different defined forget gate activation vectors of tunable forget gate activation vector 220; different defined input gate biases of tunable input gate activation vector 222; different defined input gate activation vectors of tunable input gate activation vector 222; different defined forget gate biases of tunable forget gate activation vector 302; different defined forget gate activation vectors of tunable forget gate activation vector 302; different defined input gate biases of tunable input gate activation vector 304; different defined input gate activation vectors of tunable input gate activation vector 304; and/or other different hyperparameters. For example, configuration component 108 can define different hyperparameters of multiple versions of model 200 and/or model 300, where such different hyperparameters can include, but are not limited to: tunable hyperparameter k of tunable forget gate activation vector 220 and/or tunable input gate activation vector 222; tunable hyperparameters fₜ and/or iₜ of tunable forget gate activation vector 302 and tunable input gate activation vector 304, respectively; b_{f} and bᵢ of tunable forget gate activation vector 302 and tunable input gate activation vector 304, respectively; and/or another hyperparameter.

In some embodiments, configuration component 108 can determine target hyperparameters of an AI model based on performance of such multiple versions of model 200 and/or model 300 operating according to different defined hyperparameters, where such target hyperparameters can include, but are not limited to: a target forget gate bias of tunable forget gate activation vector 220 and/or tunable forget gate activation vector 302; a target input gate bias of tunable input gate activation vector 222 and/or tunable input gate activation vector 304; a target forget gate activation vector of tunable forget gate activation vector 220 and/or tunable forget gate activation vector 302; a target input gate activation vector of tunable input gate activation vector 222 and/or tunable input gate activation vector 304; and/or another target hyperparameter. For example, configuration component 108 can determine target hyperparameters of an AI model based on performance of such multiple versions of model 200 and/or model 300 operating according to different defined hyperparameters, where such target hyperparameters can include, but are not limited to: a target hyperparameter of tunable hyperparameter k of tunable forget gate activation vector 220 and/or tunable input gate activation vector 222; target hyperparameter of tunable hyperparameters fₜ and/or iₜ of tunable forget gate activation vector 302 and tunable input gate activation vector 304, respectively; target b_{f} and bᵢ values of tunable forget gate activation vector 302 and tunable input gate activation vector 304, respectively; and/or another target hyperparameter.

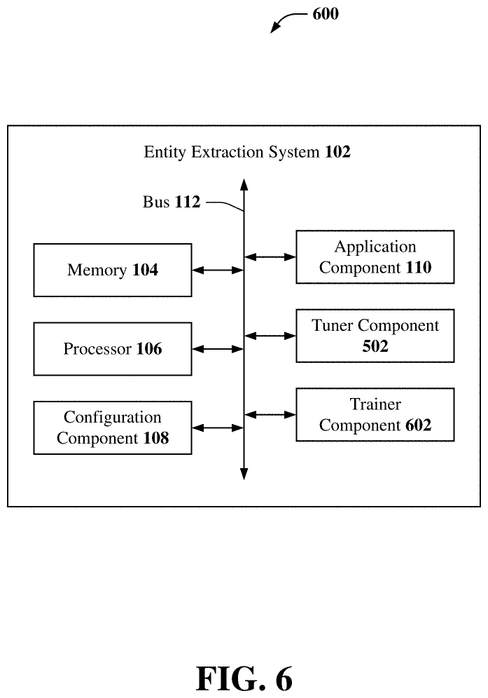

In some embodiments, configuration component 108 can define different hyperparameters of multiple versions of model 200 and/or model 300 (e.g., as described above), and determine target hyperparameters of an AI model based on performance of such multiple versions of model 200 and/or model 300, where such an AI model can comprise a collection of a plurality of AI models trained with different hyperparameters. For example, configuration component 108 can define different hyperparameters of multiple versions of model 200 and/or model 300 (e.g., as described above), and determine target hyperparameters of an AI model based on performance of multiple versions of model 200 and/or model 300, where such an AI model can comprise a collection of multiple versions of model 200 and/or model 300 that can be trained (e.g., via trainer component 602 as described below with reference to FIG. 6) with such different hyperparameters defined above. For instance, configuration component 108 can define different hyperparameters of multiple versions of model 200 and/or model 300 (e.g., as described above), and determine target hyperparameters of such an AI model described above based on performance of such multiple versions of model 200 and/or model 300, where each of such multiple versions of model 200 and/or model 300 are operating according to different defined hyperparameters that can be defined based on one or more attributes of an entity defined above.

In some embodiments, configuration component 108 can define different hyperparameters of multiple versions of model 200 and/or model 300 (e.g., as described above), and determine target hyperparameters of an AI model by selecting the hyperparameters of a best performing (e.g., most accurate) version of such multiple versions of model 200 and/or model 300. For example, configuration component 108 can define different hyperparameters of multiple versions of model 200 and/or model 300 (e.g., as described above), and determine target hyperparameters of an AI model by selecting the hyperparameters of a version of model 200 and/or model 300 that has the best loss function (e.g., a minimum loss function, a maximum loss function, etc.).

According to multiple embodiments, application component 110 can employ an AI model to extract one or more entities from a data source based on target hyperparameters of the AI model. For example, application component 110 can employ an AI model (e.g., model 200, model 300, an AI model comprising a collection of multiple versions of model 200 and/or model 300, etc.) to extract one or more entities such as, for instance, entities 402, 404, 406 described below with reference to FIG. 4 from a data source (e.g., a database, a network, a textual document, a conversation log of a cognitive conversation agent, etc.) based on target hyperparameters of the AI model. In some embodiments, such an AI model can comprise a collection of multiple versions of model 200 and/or model 300 that can each be trained (e.g., via trainer component 602 as described below with reference to FIG. 6) by designating different hyperparameters (e.g., defined above with reference to FIGS. 2 and 3) to each model version, where such different hyperparameters can be defined to extract one or more entities of a certain type, having a certain length or range of length (e.g., certain length or range of length of text spans) that correspond to a certain content domain, a certain knowledge source, and/or a certain application. In some embodiments, such target hyperparameters of such an AI model can comprise one or more of the different hyperparameters corresponding to a best performing model version (e.g., most accurate model version) of such collection of multiple versions of model 200 and/or model 300.

In some embodiments, application component 110 can employ such an AI model comprising multiple versions of model 200 and/or model 300 to extract one or more entities having defined lengths of text spans (e.g., and/or range of lengths of text spans) reflected in target hypermeter values and/or target hyperparameter values of the AI model. In some embodiments, application component 110 can employ such an AI model comprising multiple versions of model 200 and/or model 300 to extract one or more entities having defined lengths of text spans (e.g., and/or range of lengths of text spans) reflected in target hypermeter values and/or target hyperparameter values of the AI model, where such one or more entities can be of a certain type and/or correspond to a certain content domain, a certain knowledge source, and/or a certain application as described above.

FIG. 4 illustrates example, non-limiting information 400 that can facilitate extraction of entities having defined lengths of text spans in accordance with one or more embodiments described herein. For example, information 400 can facilitate extraction of one or more entities that require different lengths of context span to be classified correctly, for instance, by a model (e.g., model 200, model 300, an AI model, a ML model, etc.). Repetitive description of like elements and/or processes employed in respective embodiments is omitted for sake of brevity.

According to multiple embodiments, information 400 can comprise one or more entities 402, 404, 406. In some embodiments, entities 402, 404, 406 can comprise various types of entities having various attributes, where such entities can correspond to various content domains, various knowledge sources, and/or various applications. For example, entities 402, 404, 406 can comprise various types of entities having various lengths and/or various sequence lengths (e.g., various quantities of text characters and/or words in a single entity and/or in a sequence of entities), where such entities can correspond to various content domains (e.g., information technology (IT), finance, health care, etc.), various knowledge sources (e.g., a database, a network, a textual document, a conversation log of a cognitive conversation agent, a data graph, a semantic engine, inference engine, etc.), and/or various applications (e.g., a search engine, a cognitive conversation agent, a cognitive expert agent, etc.). In some embodiments, entities 402, 404, 406 can comprise various spans of textual objects (e.g., various spans of textual characters) including, but not limited to, a phoneme, a syllable, a letter, a word, a sentence, a paragraph, and/or another textual object.

In some embodiments, entities 402, 404, 406 can be extracted (e.g., via model 200, model 300, application component 110, etc.) from an information technology (IT) domain. In some embodiments, entities 402, 404, 406 can be extracted (e.g., via model 200, model 300, application component 110, etc.) from a knowledge source such as, for instance, a conversation log of a cognitive conversation agent. In some embodiments, entities 402, 404, 406 can be extracted (e.g., via model 200, model 300, application component 110, etc.) from an application such as, for instance, a cognitive conversation agent and/or a cognitive expert agent.

In some embodiments, entity 402 depicted as bold text in FIG. 4 can comprise a symptom (e.g., a symptom describing a malfunctioning computing device, computing application, etc.). In some embodiments, entity 404 depicted as underlined text in FIG. 4 can comprise a resolution (e.g., a resolution corresponding to a symptom describing a malfunctioning computing device, computing application, etc.). In some embodiments, entity 406 depicted as italicized text in FIG. 4 can comprise an action request (e.g., an action request corresponding to a symptom describing a malfunctioning computing device, computing application, etc.).

In some embodiments, entity extraction system 102 can learn one or more entities having different lengths of text spans. For example, entity extraction system 102 can employ trainer component 602 described below with reference to FIG. 6 to learn, for instance, entities 402, 404, 406 comprising different types of entities (e.g., symptom, resolution, action request, etc.) having different lengths of text spans that require different context span for accurate classification (e.g., different quantity of text characters, different quantity of words, different quantity of sentences, etc.).

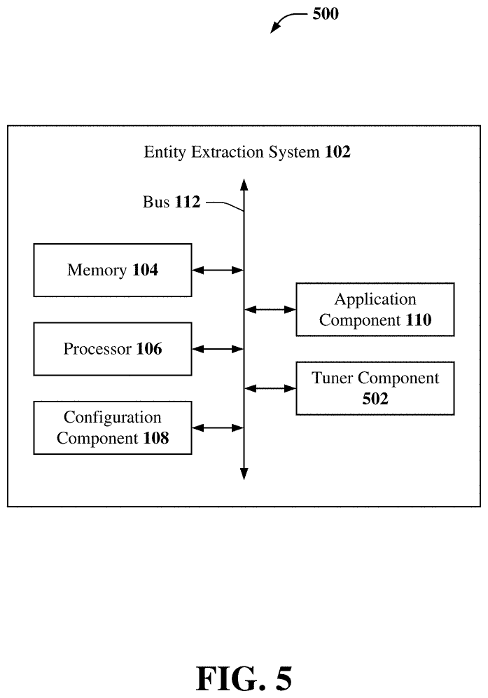

FIG. 5 illustrates a block diagram of an example, non-limiting system 500 that can facilitate extraction of entities having defined lengths of text spans in accordance with one or more embodiments described herein. For example, system 500 can facilitate extraction of one or more entities that require different lengths of context span to be classified correctly, for instance, by a model (e.g., model 200, model 300, an AI model, a ML model, etc.). In some embodiments, entity extraction system 102 can comprise a tuner component 502. Repetitive description of like elements and/or processes employed in respective embodiments is omitted for sake of brevity.

According to multiple embodiments, tuner component 502 can tune one or more hyperparameters of one or more AI models to define different hyperparameters of such one or more AI models. For example, tuner component 502 can tune (e.g., adjust to a desired setting and/or value) one or more hyperparameters including, but not limited to: tunable hyperparameter k of tunable forget gate activation vector 220 and/or tunable input gate activation vector 222; tunable hyperparameters fₜ and/or iₜ of tunable forget gate activation vector 302 and tunable input gate activation vector 304, respectively; b_{f} and bᵢ of tunable forget gate activation vector 302 and tunable input gate activation vector 304, respectively; and/or another hyperparameter.

In some embodiments, tuner component 502 can tune one or more of such hyperparameters defined above of an AI model comprising multiple versions of model 200 and/or model 300 to define different hyperparameters of such AI model. For example, based on performance (e.g., undesired performance, low performance, undesired loss function results, etc.) of one or more of such multiple versions of model 200 and/or model 300, tuner component 502 can tune one or more of such hyperparameters defined above corresponding to any and/or all of such multiple versions of model 200 and/or model 300 to define different hyperparameters of an AI model comprising such multiple versions of model 200 and/or 300.

FIG. 6 illustrates a block diagram of an example, non-limiting system 600 that can facilitate extraction of entities having defined lengths of text spans in accordance with one or more embodiments described herein. For example, system 600 can facilitate extraction of one or more entities that require different lengths of context span to be classified correctly, for instance, by a model (e.g., model 200, model 300, an AI model, a ML model, etc.). In some embodiments, entity extraction system 102 can comprise a trainer component 602. Repetitive description of like elements and/or processes employed in respective embodiments is omitted for sake of brevity.

According to multiple embodiments, trainer component 602 can train one or more AI models to learn entities having different lengths of text spans based on different defined hyperparameters of such one or more AI models. For example, trainer component 602 can train one or more versions of, for instance, model 200 and/or model 300 to learn entities having different lengths of text spans (e.g., and/or range of lengths of text spans) by assigning (e.g., defining) different hyperparameters (e.g., defined above with reference to FIGS. 2 and 3) to each model version, where such different hyperparameters can be defined to extract one or more entities of a certain type, having a certain length or range of length (e.g., certain length or range of length of text spans) that correspond to a certain content domain, a certain knowledge source, and/or a certain application.

In some embodiments, to facilitate training such one or more AI models to learn such entities, trainer component 602 can assign (e.g., define) different original hyperparameters to each of such one or more AI models and based on performance (e.g., inaccurate results, undesired loss function value, etc.) of such one or more AI models using such originally defined hyperparameters, trainer component 602 can employ tuner component 502 to adjust one or more of such originally defined hyperparameters of such one or more AI models that do not provide desired results when employing the originally defined hyperparameters. In some embodiments, trainer component 602 can repeat such a hyperparameter fine tuning process described above to determine one or more target hyperparameters of such one or more AI models that can facilitate desired performance of such one or more AI models in extracting one or more entities of a certain type, having a certain length or range of length (e.g., certain length or range of length of text spans) that correspond to a certain content domain, a certain knowledge source, and/or a certain application.

In some embodiments, such originally defined hyperparameters and/or hyperparameters revised by tuner component 502 can comprise historical data (e.g., labeled training data) corresponding to such one or more AI models defined above. In some embodiments, trainer component 602 can compile such historical data into a historical data index (e.g., a log) that can be stored on a memory device such as, for instance, memory 104 and/or a remote memory device (e.g., a memory device of a remote server).

In some embodiments, such historical data can comprise training data (e.g., labeled training data) that trainer component 602 can use to train such one or more AI models to learn entities having different lengths of text spans based on different defined hyperparameters of such one or more AI models. For example, trainer component 602 can comprise and/or employ one or more AI models defined above to train such one or more AI models to learn such entities based on explicit learning and/or implicit learning. For instance, trainer component 602 can comprise and/or employ such one or more AI models defined above to learn such entities based on explicit learning (e.g., supervised learning, reinforcement learning, etc.). In this example, previously obtained historical data (e.g., labeled training data and/or previously obtained performance data corresponding to such one or more AI models operating according to different hyperparameters) can be used by trainer component 602 as training data. In another example, trainer component 602 can comprise and/or employ one or more AI models defined above to train such one or more AI models to learn such entities based on implicit learning (e.g., unsupervised learning). In this example, newly obtained performance data corresponding to each of such one or more AI models operating according to different hyperparameters can be used by trainer component 602 as training data to learn which AI model(s) is most accurate in extracting certain entity types, having certain length(s) and/or range of length(s) that correspond to a certain contain domain, a certain knowledge source, and/or a certain application.

In an embodiment, trainer component 602 can facilitate such training of such one or more AI models described above based on classifications, correlations, inferences and/or expressions associated with principles of artificial intelligence. For instance, trainer component 602 can employ an automatic classification system and/or an automatic classification process to facilitate such training of such one or more AI models described above. In one embodiment, trainer component 602 can employ a probabilistic and/or statistical-based analysis (e.g., factoring into the analysis utilities and costs) to facilitate such training of such one or more AI models described above.

In some embodiments, trainer component 602 can employ any suitable machine learning based techniques, statistical-based techniques, and/or probabilistic-based techniques to facilitate such training of such one or more AI models described above. For example, trainer component 602 can employ an expert system, fuzzy logic, support vector machine (SVM), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or another model. In some embodiments, trainer component 602 can perform a set of machine learning computations associated with training of such one or more AI models described above to learn such entities. For example, trainer component 602 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations to facilitate such training of such one or more AI models described above.

In some embodiments, configuration component 108 can determine target hyperparameters of an AI model based on performance of multiple AI models. For example, configuration component 108 can determine target hyperparameters of an AI model by selecting the hyperparameters of a best performing (e.g., most accurate) version of the multiple versions of model 200, model 300, and/or one or more combinations thereof, that can be trained by trainer component 602 as described above. For instance, trainer component 602 can train multiple versions of model 200, model 300, and/or one or more combinations thereof, where each of such model versions can operate according to different hyperparameters to learn certain length entities of a certain type that correspond to a certain content domain, a certain knowledge source, and/or a certain application. In this example, configuration component 108 can determine target hyperparameters of an AI model by selecting the hyperparameters of a version of model 200, model 300, and/or a combination thereof, that has the best loss function (e.g., a minimum loss function, a maximum loss function, etc.).

In some embodiments, entity extraction system 102 can be associated with various technologies. For example, entity extraction system 102 can be associated with language model technologies, information retrieval technologies, information extraction technologies, cognitive computing technologies, conversation agent technologies, data analytics technologies, graph analytics technologies, artificial intelligence technologies, machine learning technologies, computer technologies, server technologies, information technology (IT) technologies, internet-of-things (IoT) technologies, automation technologies, and/or other technologies.

In some embodiments, entity extraction system 102 can provide technical improvements to systems, devices, components, operational steps, and/or processing steps associated with the various technologies identified above. For example, entity extraction system 102 can automatically (e.g., without assistance from a human) learn to extract entities having different lengths of text spans (e.g., and/or range of lengths of text spans) by assigning (e.g., defining) different hyperparameters (e.g., defined above with reference to FIGS. 2 and 3) to multiple versions of one or more AI models (e.g., model 200, model 300, and/or combination thereof). In this example, entity extraction system 102 can further determine target hyperparameters of an AI model (e.g., model 200, model 300, and/or combination thereof) by selecting the hyperparameters of a best performing model version of the one or more AI models. In this example, such different hyperparameters can be defined to extract one or more entities of a certain type, having a certain length or range of length (e.g., certain length or range of length of text spans) that correspond to a certain content domain, a certain knowledge source, and/or a certain application. In this example, by determining such target hyperparameters that enable an AI model to produce the most accurate results in extracting such entities defined above, entity extraction system 102 can facilitate improved memory capacity, improved accuracy, and/or reduced execution cost of such an AI model, thereby providing technical improvements and/or advantages over existing technologies.

In some embodiments, entity extraction system 102 can provide technical improvements to a processing unit (e.g., processor 106) associated with a classical computing device and/or a quantum computing device (e.g., a quantum processor, quantum hardware, superconducting circuit, etc.). For example, by determining such target hyperparameters that can facilitate such improved memory capacity, improved accuracy, and/or reduced execution cost of an AI model that can extract such entities defined above, entity extraction system 102 can thereby facilitate improved accuracy, efficiency, and/or performance of a processing unit (e.g., processor 106) associated with such an AI model (e.g., model 200, model 300, one or more combinations thereof, etc.).

In some embodiments, entity extraction system 102 can employ hardware and/or software to solve problems that are highly technical in nature, that are not abstract and that cannot be performed as a set of mental acts by a human. For example, entity extraction system 102 and/or components thereof can employ such hardware and/or software to: a) simultaneously train multiple artificial intelligence models to learn entities having different lengths of text spans based on different defined hyperparameters of the multiple artificial intelligence models; b) determine target hyperparameters of an artificial intelligence model based on performance of the multiple artificial intelligence models; and/or c) employ the artificial intelligence model to extract one or more entities from a data source based on the target hyperparameters. In this example, entity extraction system 102 and/or components thereof can employ and/or solve various complex mathematical functions and/or algorithms (e.g., the equations described above with reference to FIG. 3A) comprising a multitude of variables to facilitate execution of such operations described above and/or other operations of entity extraction system 102 and/or components thereof as described herein. In some embodiments, some of the processes described herein can be performed by one or more specialized computers (e.g., one or more specialized processing units, a specialized quantum computer, etc.) for carrying out defined tasks related to the various technologies identified above. In some embodiments, entity extraction system 102 and/or components thereof, can be employed to solve new problems that arise through advancements in technologies mentioned above, employment of quantum computing systems, cloud computing systems, computer architecture, and/or another technology.

It is to be appreciated that entity extraction system 102 can utilize various combinations of electrical components, mechanical components, and circuitry that cannot be replicated in the mind of a human or performed by a human, as the various operations that can be executed by entity extraction system 102 and/or components thereof as described herein are operations that are greater than the capability of a human mind. For instance, the amount of data processed, the speed of processing such data, or the types of data processed by entity extraction system 102 over a certain period of time can be greater, faster, or different than the amount, speed, or data type that can be processed by a human mind over the same period of time.

According to several embodiments, entity extraction system 102 can also be fully operational towards performing one or more other functions (e.g., fully powered on, fully executed, etc.) while also performing the various operations described herein. It should be appreciated that such simultaneous multi-operational execution is beyond the capability of a human mind. It should also be appreciated that entity extraction system 102 can include information that is impossible to obtain manually by an entity, such as a human user. For example, the type, amount, or variety of information included in entity extraction system 102, configuration component 108, application component 110, model 200, model 300, tuner component 502, and/or trainer component 602 can be more complex than information obtained manually by a human user.

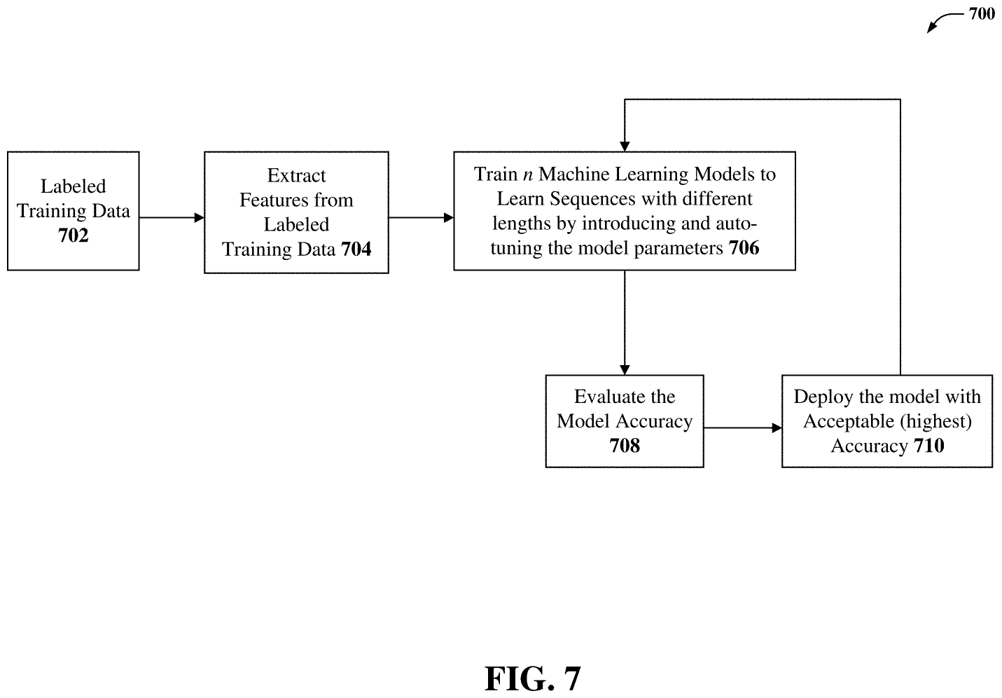

FIG. 7 illustrates a flow diagram of an example, non-limiting computer-implemented method 700 that can facilitate extraction of entities having defined lengths of text spans in accordance with one or more embodiments described herein. For example, computer-implemented method 700 can facilitate extraction of one or more entities that require different lengths of context span to be classified correctly, for instance, by a model (e.g., model 200, model 300, an AI model, a ML model, etc.). Repetitive description of like elements and/or processes employed in respective embodiments is omitted for sake of brevity.

In some embodiments, at 702, computer-implemented method 700 can comprise receiving labeled training data. For example, entity extraction system 102 and/or trainer component 602 can receive labeled training data such as, for instance, historical data comprising previously obtained performance data corresponding to the one or more AI models operating according to different hyperparameters as described above with reference to FIGS. 5 and 6. In some embodiments, entity extraction system 102 and/or trainer component 602 can receive such labeled training data via an interface component of entity extraction system 102 (e.g., a graphical user interface (GUI)).

In some embodiments, at 704, computer-implemented method 700 can comprise extracting (e.g., via configuration component 108, application component 110, model 200, model 300, a AI model comprising a combination of model 200 and model 300, trainer component 602, etc.) features from labeled training data (e.g., the labeled training data of operation 702).

In some embodiments, at 706, computer-implemented method 700 can comprise training (e.g., via trainer component 602) n (e.g., n number of) machine learning models (e.g., multiple variations of model 200 and/or model 300 and/or combinations thereof) to learn sequences (e.g., entity sequences) with different lengths by introducing (e.g., defining via configuration component 108) and auto-tuning (e.g., tuning via tuner component 502) the model parameters (e.g., hyperparameters defined above with reference to FIGS. 2 and 3).

In some embodiments, at 708, computer-implemented method 700 can comprise evaluating (e.g., via configuration component 108 and/or trainer component 602) the model accuracy (e.g., the performance of any and/or all of such n machine learning models of operation 706 each operating according to different hyperparameters, as described above with reference to FIGS. 1, 2, 3, 5, and 6).

In some embodiments, at 710, computer-implemented method 700 can comprise deploying (e.g., via application component 110) the model with acceptable (e.g., highest) accuracy (e.g., the AI and/or machine learning model that can facilitate desired performance in extracting one or more entities of a certain type, having a certain length or range of length that correspond to a certain content domain, a certain knowledge source, and/or a certain application). In some embodiments (not illustrated in FIG. 7), computer-implemented method 700 can comprise repeating operations 706, 708, and/or 710 as the features of incoming data changes (e.g., the sequence of text to be extracted increase or decrease in length) to facilitate retraining the model (e.g., retraining, via trainer component 602, an AI model comprising a collection of multiple variations of model 200, model 300, and/or one or more combinations thereof).

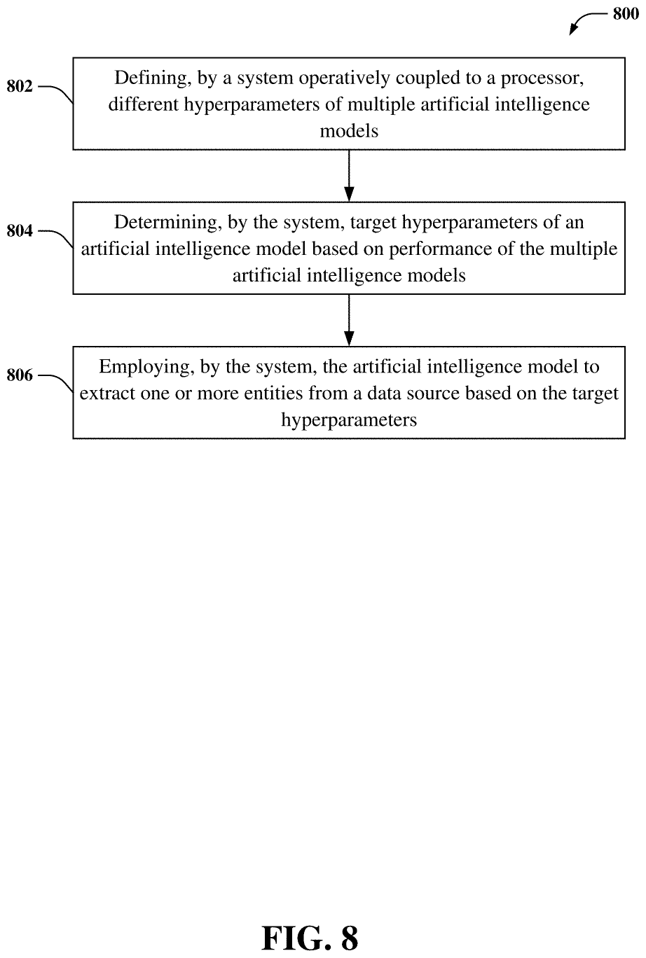

FIG. 8 illustrates a flow diagram of an example, non-limiting computer-implemented method 800 that can facilitate extraction of entities having defined lengths of text spans in accordance with one or more embodiments described herein. For example, computer-implemented method 800 can facilitate extraction of one or more entities that require different lengths of context span to be classified correctly, for instance, by a model (e.g., model 200, model 300, an AI model, a ML model, etc.). Repetitive description of like elements and/or processes employed in respective embodiments is omitted for sake of brevity.

In some embodiments, at 802, computer-implemented method 800 can comprise defining, by a system (e.g., entity extraction system 102 and/or configuration component 108) operatively coupled to a processor (e.g., processor 106), different hyperparameters (e.g., the hyperparameters defined above with reference to FIGS. 2 and 3) of multiple artificial intelligence models (e.g., multiple variations of model 200, model 300, and/or one or more combinations thereof).

In some embodiments, at 804, computer-implemented method 800 can comprise determining, by the system (e.g., entity extraction system 102 and/or configuration component 108), target hyperparameters of an artificial intelligence model (e.g., an AI model comprising a collection of multiple variations of model 200, model 300, and/or one or more combinations thereof) based on performance of the multiple artificial intelligence models (e.g., accuracy of results, performance as measured based on a loss function, etc.).

In some embodiments, at 806, computer-implemented method 800 can comprise employing, by the system (e.g., entity extraction system 102 and/or application component 110), the artificial intelligence model to extract one or more entities (e.g., entities 402, 404, 406) from a data source based on the target hyperparameters.

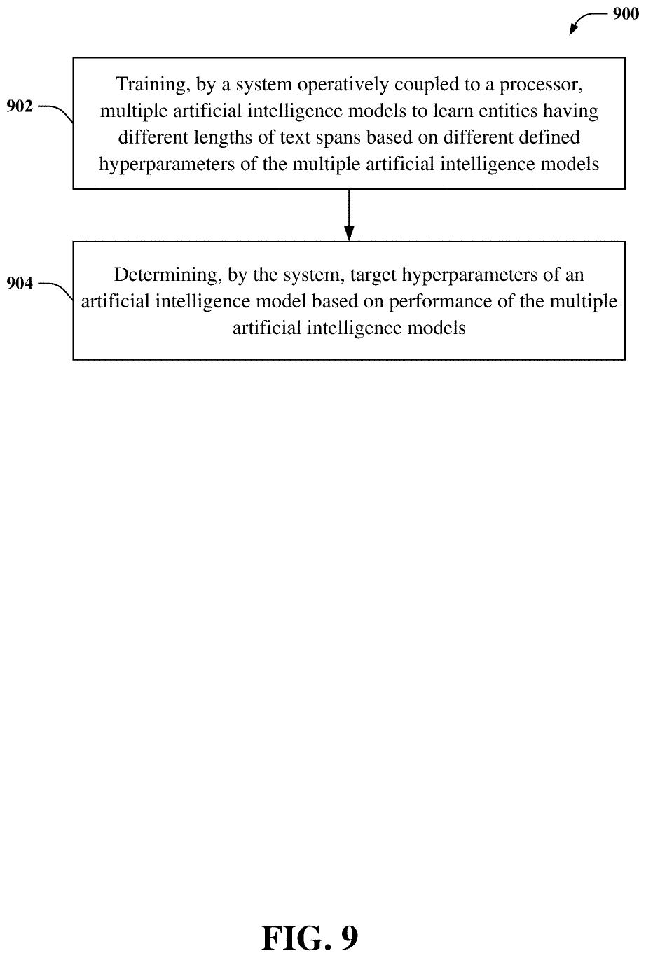

FIG. 9 illustrates a flow diagram of an example, non-limiting computer-implemented method 900 that can facilitate extraction of entities having defined lengths of text spans in accordance with one or more embodiments described herein. For example, computer-implemented method 900 can facilitate extraction of one or more entities that require different lengths of context span to be classified correctly, for instance, by a model (e.g., model 200, model 300, an AI model, a ML model, etc.). Repetitive description of like elements and/or processes employed in respective embodiments is omitted for sake of brevity.

In some embodiments, at 902, computer-implemented method 900 can comprise training, by a system (e.g., entity extraction system 102 and/or trainer component 602) operatively coupled to a processor (e.g., processor 106), multiple artificial intelligence models to learn entities (e.g., entities 402, 404, 406) having different defined lengths of text spans based on different defined hyperparameters (e.g., different defined hyperparameters as described above with reference to FIGS. 1, 2, 3, 5, and 6) of the multiple artificial intelligence models.

In some embodiments, at 904, computer-implemented method 900 can comprise determining, by the system (e.g., entity extraction system 102 and/or configuration component 108), target hyperparameters of an artificial intelligence model (e.g., an AI model comprising a collection of multiple variations of model 200, model 300, and/or one or more combinations thereof) based on performance of the multiple artificial intelligence models (e.g., accuracy of results, performance as measured based on a loss function, etc.).

For simplicity of explanation, the computer-implemented methodologies are depicted and described as a series of acts. It is to be understood and appreciated that the subject innovation is not limited by the acts illustrated or by the order of acts, for example acts can occur in various orders or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements and/or processes employed in other embodiments described herein is omitted for sake of brevity.

With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media. To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012.

System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

Referring now to FIG. 11, an illustrative cloud computing environment 1150 is depicted. As shown, cloud computing environment 1150 includes one or more cloud computing nodes 1110 with which local computing devices used by cloud consumers, such as, for example, personal digital assistant (PDA) or cellular telephone 1154A, desktop computer 1154B, laptop computer 1154C, and/or automobile computer system 1154N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices 1154A-N shown in FIG. 11 are intended to be illustrative only and that computing nodes 1110 and cloud computing environment 1150 can communicate with any type of computerized device over any type of network and/or network addressable connection (e.g., using a web browser).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 12, a set of functional abstraction layers provided by cloud computing environment 1150 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfillment 1285 provide pre-arrangement for, and procurement of, cloud computing resources for which a future requirement is anticipated in accordance with an SLA.

Workloads layer 1290 provides examples of functionality for which the cloud computing environment may be utilized. Non-limiting examples of workloads and functions which may be provided from this layer include: mapping and navigation 1291; software development and lifecycle management 1292; virtual classroom education delivery 1293; data analytics processing 1294; transaction processing 1295; and entity extraction software 1296.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a configuration component that defines different hyperparameters of multiple artificial intelligence models, and determines target hyperparameters of an artificial intelligence model based on performance of the multiple artificial intelligence models; and
an application component that employs the artificial intelligence model to extract one or more entities from a data source based on the target hyperparameters.

2. The system of claim 1, wherein the artificial intelligence model comprises a collection of a plurality of artificial intelligence models trained with various hyperparameters.

3. The system of claim 1, wherein at least one of the artificial intelligence model or the multiple artificial intelligence models comprise at least one of a deep neural network model, a recurring neural network model, a long short term memory model, an elastic long short term memory model, or a decoupled elastic long short term memory model.

4. The system of claim 1, wherein the target hyperparameters comprise a target forget gate bias and a target input gate bias of the artificial intelligence model, and wherein the different hyperparameters comprise different defined forget gate biases and different defined input gate biases of the multiple artificial intelligence models.

5. The system of claim 1, wherein the different hyperparameters are defined based on at least one of different content domains, different knowledge sources, different data types, or different applications.

6. The system of claim 1, wherein the computer executable components further comprise:
a tuner component that tunes one or more hyperparameters of the multiple artificial intelligence models to define the different hyperparameters of the multiple artificial intelligence models.

7. The system of claim 1, wherein the application component employs the artificial intelligence model to extract one or more entities having defined lengths of text spans reflected in at least one of target hypermeter values or target hyperparameter values, thereby facilitating at least one of improved memory capacity, improved accuracy, or reduced execution cost of the artificial intelligence model.

8. A computer-implemented method, comprising:
defining, by a system operatively coupled to a processor, different hyperparameters of multiple artificial intelligence models;
determining, by the system, target hyperparameters of an artificial intelligence model based on performance of the multiple artificial intelligence models; and
employing, by the system, the artificial intelligence model to extract one or more entities from a data source based on the target hyperparameters.

9. The computer-implemented method of claim 8, wherein at least one of the artificial intelligence model or the multiple artificial intelligence models comprise at least one of a deep neural network model, a recurring neural network model, a long short term memory model, an elastic long short term memory model, or a decoupled elastic long short term memory model.

10. The computer-implemented method of claim 8, wherein the target hyperparameters comprise a target forget gate bias and a target input gate bias of the artificial intelligence model, and wherein the different hyperparameters comprise different defined forget gate biases and different defined input gate biases of the multiple artificial intelligence models.

11. The computer-implemented method of claim 8, further comprising:
defining, by the system, the different hyperparameters based on at least one of different content domains, different knowledge sources, different data types, or different applications.

12. The computer-implemented method of claim 8, further comprising:
tuning, by the system, one or more hyperparameters of the multiple artificial intelligence models to define the different hyperparameters of the multiple artificial intelligence models.

13. A computer program product facilitating extraction of entities having defined lengths of text spans, the computer program product comprising a computer readable storage medium having program instructions embodied therewith, the program instructions executable by a processor to cause the processor to:
define, by the processor, different hyperparameters of multiple artificial intelligence models;
determine, by the processor, target hyperparameters of an artificial intelligence model based on performance of the multiple artificial intelligence models; and
employ, by the processor, the artificial intelligence model to extract one or more entities from a data source based on the target hyperparameters.

14. The computer program product of claim 13, wherein at least one of the artificial intelligence model or the multiple artificial intelligence models comprise at least one of a deep neural network model, a recurring neural network model, a long short term memory model, an elastic long short term memory model, or a decoupled elastic long short term memory model.

15. The computer program product of claim 13, wherein the target hyperparameters comprise a target forget gate bias and a target input gate bias of the artificial intelligence model, and wherein the different hyperparameters comprise different defined forget gate biases and different defined input gate biases of the multiple artificial intelligence models.

16. The computer program product of claim 13, wherein the program instructions are further executable by the processor to cause the processor to:
define, by the processor, the different hyperparameters based on at least one of different content domains, different knowledge sources, different data types, or different applications.

17. The computer program product of claim 13, wherein the program instructions are further executable by the processor to cause the processor to:
tune, by the processor, one or more hyperparameters of the multiple artificial intelligence models to define the different hyperparameters of the multiple artificial intelligence models, thereby facilitating at least one of improved memory capacity, improved accuracy, or reduced execution cost of the artificial intelligence model.

18. A system, comprising:
a memory that stores computer executable components; and
a processor that executes the computer executable components stored in the memory, wherein the computer executable components comprise:
a trainer component that trains multiple artificial intelligence models to learn entities having different lengths of text spans based on different defined hyperparameters of the multiple artificial intelligence models; and
a configuration component that determines target hyperparameters of an artificial intelligence model based on performance of the multiple artificial intelligence models.

19. The system of claim 18, wherein at least one of the artificial intelligence model or the multiple artificial intelligence models comprise at least one of a deep neural network model, a recurring neural network model, a long short term memory model, an elastic long short term memory model, or a decoupled elastic long short term memory model.

20. The system of claim 18, wherein the target hyperparameters comprise a target forget gate bias and a target input gate bias of the artificial intelligence model, and wherein the different defined hyperparameters comprise different defined forget gate biases and different defined input gate biases of the multiple artificial intelligence models.

21. The system of claim 18, wherein the computer executable components further comprise:
a tuner component that tunes one or more hyperparameters of the multiple artificial intelligence models to define the different defined hyperparameters of the multiple artificial intelligence models, and wherein the different defined hyperparameters are defined based on at least one of different content domains, different knowledge sources, different data types, or different applications.

22. A computer-implemented method, comprising:
training, by a system operatively coupled to a processor, multiple artificial intelligence models to learn entities having different lengths of text spans based on different defined hyperparameters of the multiple artificial intelligence models; and
determining, by the system, target hyperparameters of an artificial intelligence model based on performance of the multiple artificial intelligence models.

23. The computer-implemented method of claim 22, wherein at least one of the artificial intelligence model or the multiple artificial intelligence models comprise at least one of a deep neural network model, a recurring neural network model, a long short term memory model, an elastic long short term memory model, or a decoupled elastic long short term memory model.

24. The computer-implemented method of claim 22, wherein the target hyperparameters comprise a target forget gate bias and a target input gate bias of the artificial intelligence model, and wherein the different defined hyperparameters comprise different defined forget gate biases and different defined input gate biases of the multiple artificial intelligence models.

25. The computer-implemented method of claim 22, further comprising:
tuning, by the system, one or more hyperparameters of the multiple artificial intelligence models to define the different defined hyperparameters of the multiple artificial intelligence models, wherein the different defined hyperparameters are defined based on at least one of different content domains, different knowledge sources, different data types, or different applications.
